(19) United States
(12) Patent Application Publication
(10) Pub. No.: US 2007/0110954 A1
(43) Pub. Date: May 17, 2007

(54) Vehicular clamping strip having an optical locking cord

(75) Inventor: William Whitehead, Maryville, TN (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York, NY (US)

(21) Appl. No.: 11/280,053

(22) Filed: Nov. 16, 2005

(51) Int. Cl. B32B 3/04

(52) U.S. Cl. 428/122

(57) ABSTRACT

A vehicular clamping strip includes a clamping channel and an optical locking cord for disposing the clamping channel in a clamping configuration to secure the clamping channel relative to the vehicle. The optical locking cord is at least one of light emitting, light generating and specularly reflective.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to vehicular clamping strips, such as flange engaging strips and weatherseals, and particularly, to a vehicular clamping strip having an optical locking cord for securing a clamping channel to the vehicle, wherein the optical locking cord is at least one of light generating, light emitting or specularly reflective.

2. Description of Related Art

U.S. Pat. No. 2,637,880 discloses a self-sealing window strip, wherein a mounting strip receives a peripheral edge of two adjacent windows and a locking strip is disposed along a lateral edge of the window strip, between the peripheral edges of the windows, to engage the window strip with the windows.

Similarly, U.S. Pat. No. 2,492,566 discloses a connector strip for engaging peripheral edges of a pair of windows, wherein the connector strip includes a wedge for engaging a lateral portion of the connector strip.

The need exists for a vehicular clamping strip that can operably engage a variety of flange thicknesses, while providing additional functionality. The need also exists for such a clamping strip that can be readily installed. A further need exists for a locking cord actuated clamping strip, wherein the locking cord provides optical properties. A need also exists for a vehicular clamping strip having an optical locking cord that can provide a sealing or a trimming function of a vehicular weatherseal.

### BRIEF SUMMARY OF THE INVENTION

The present invention provides a vehicular clamping strip, such as a weatherseal, that can operably engage a variety of flange thicknesses wherein an optical locking cord disposes the vehicular clamping strip in a clamping state.

The present invention provides a clamping strip including a clamping channel having a first closed end and a pair of projecting legs sized to receive a portion of a flange, an outer surface of the clamping channel including a spreader jaw and an optical locking cord cooperatively engaging the spreader jaw to secure the clamping channel to the flange, wherein the optical locking cord is at least one of light generating, light emitting or specularly reflective.

In further constructions, the vehicular clamping strip includes a panel contacting member extending from one of the projecting legs for contacting a spaced panel, and the optical locking cord forms an exposed surface of the clamping strip.

### BRIEF DESCRIPTION OF THE SEVERAL VIEWS OF THE DRAWING(S)

FIG. 1 is a perspective view of a motor vehicle, showing an operable location of the clamping strip.

FIG. 2 is a side elevational view of the vehicle of FIG. 1.

FIG. 3 is an exploded view of a construction of the clamping strip in an uninstalled configuration.

FIG. 4 is the clamping strip of FIG. 3 in an installed configuration.

FIG. 5 is a cross-sectional view of a door seal in an uninstalled configuration.

FIG. 6 is a cross sectional view of the door seal of FIG. 5 in an installed configuration.

FIG. 7 is a cross sectional view of a glass run seal in an uninstalled configuration.

FIG. 8 is a cross sectional view of the glass run seal of FIG. 7 in an installed configuration.

FIG. 9 is a cross sectional view of a beltline seal in an uninstalled configuration.

FIG. 10 is a cross sectional view of the beltline seal of FIG. 9 in an installed configuration.

### DETAILED DESCRIPTION OF THE INVENTION

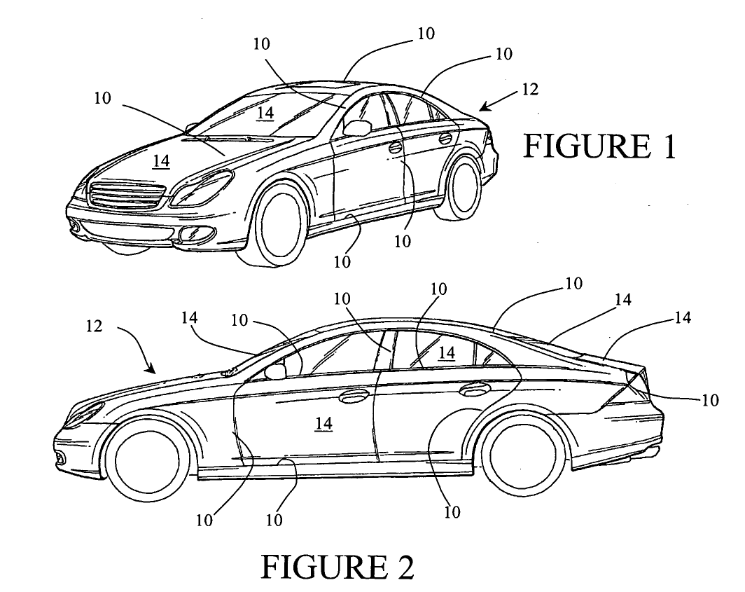

Referring to FIG. 1, a clamping strip 10 of the present invention is employed in a motor vehicle 12. The clamping strip 10 can be configured as a dynamic or static weatherseal as well as a trim piece.

Therefore, the term clamping strip 10 includes, but is not limited to, weatherseal extrusions, moldings, trim, trim pieces, edge pieces and seals. In the motor vehicle industry, the clamping strip 10 is suitable for use in many areas including, but not limited to, door seals, roof rails, deck lids, trunk lids, back window seals, belt line seals, fixed window seals, windshields, front hood seals, hood-to-cowl seals, sun roof seals, lower door seals and moveable window seals. In the weatherseal configuration, the clamping strip 10 can be used in a variety of locations on the vehicle for releasably and repeatedly engaging a panel 14 or fixedly engaging the panel.

The panel 14 can be any of a variety of materials and does not limit the present invention. For example, the panel 14 can be glass, metal or a composite, which is painted, surface treated or bare. In the operating environment, the panel 14 can be brought repeatedly into and out of engagement with the weatherseal 10. The engagement of the panel 14 and the clamping strip 10 can result from motion of the panel relative to the weatherseal. Alternatively, the clamping strip 10 can be moved relative to the panel 14. It is also contemplated the clamping strip 10 can be located about a fixed panel 14 such as a front or rear window. It is also understood the clamping strip 10 can be a trim piece of the vehicle, such as an interior trim piece.

The clamping strip 10 can cooperatively engage a flange 16 of the vehicle, as well as the panel 14, such as a window. Thus, the term flange is intended to encompass body panel edges and seams as well as fixed or static windows.

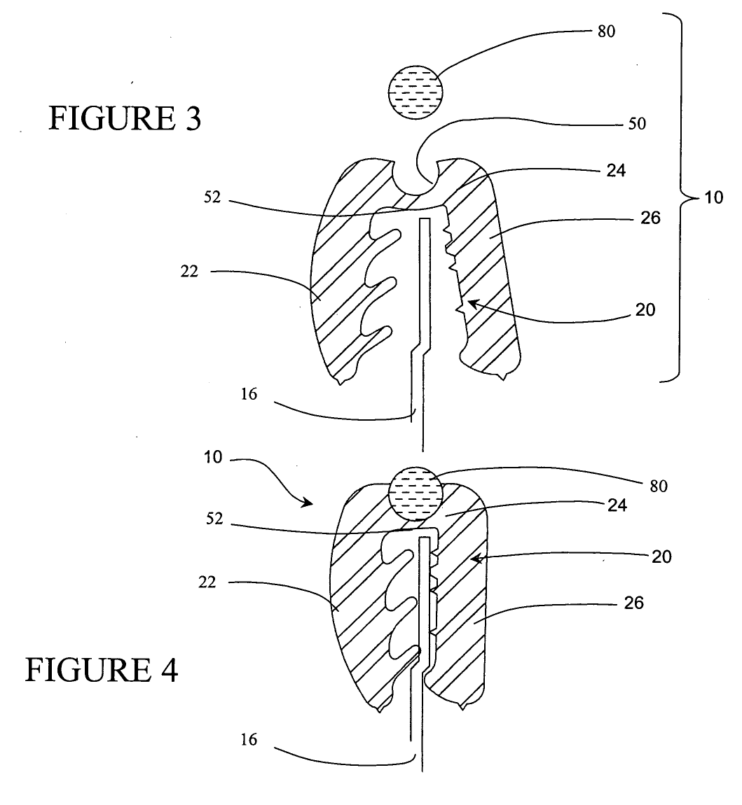

Referring to FIGS. 3-10, the clamping strip 10 includes a clamping channel 20 and an optical locking cord 80.

The clamping channel 20, in cross section, is defined by a first leg 22, a closed end 24 and a second leg 26 projecting from the closed end 24.

The clamping channel 20 can include one or more gripping fins 28 on an inside surface of the channel for firmly securing the clamping strip 10 to the vehicle 12, such as the flange 16. The gripping fins 28 can be formed by the variety of materials known in the art, such as thermosets or thermoplastics, including a sponge or foamed material of reduced density. The number, sizing and spacing of the gripping fins 28 can be selected in view of the anticipated flange thickness and variations to be accommodated. Further, the gripping fins 28 can be of the same, a harder or a softer material than the remainder of the clamping channel 20. It is also contemplated, the gripping fins 28 can include two or more portions of differing durometer materials. The gripping fins 28 are optional and can be eliminated, as the engagement of the optical locking cord 80 and the clamping channel 20 can be selected to operably retain the clamping strip 20 on the flange 16 without requiring the gripping fins.

The closed end 24 connects the first leg 22 to the second leg 26 and has a generally curvilinear cross section. However, it is understood the closed end 24 can be curvilinear or faceted. An outside surface of the clamping channel 20, such as the closed end 24 includes a spreader jaw 50 sized to cooperatively engage the optical locking cord 80. Generally, the spreader jaw 50 terminates at a hinge 52. In one configuration, the spreader jaw 50 extends through a substantial thickness of the closed end 24 of the clamping channel 20, such that the hinge 52 is defined by the remaining thickness of the closed end 24. The spreader jaw 50 defines a pair of spaced legs moveable between a loaded position retaining the optical locking cord 80 so as to secure, or clamp the clamping channel 20 with the flange 16 and an unloaded position free of the optical locking cord so as to allow the flange to be inserted within the clamping channel. The spreader jaw 50 can be any of a number of cross-sectional profiles including, but not limited to, generally circular, oval, triangular, rectangular, curvilinear or faceted.

It is also understood the unloaded position of the legs 22, 26 can be splayed (diverging), parallel or converging, and the loaded position of the legs can be splayed (diverging), parallel or converging depending upon the construction of the clamping channel 20 and the respective flange. For example, if the legs 22, 26 are converging in the unloaded position, the insertion of the optical locking cord 80 into the spreader jaw may create a clamping force between the legs, without substantial movement of the legs. Alternatively, insertion of the optical locking cord 80 into the spreader jaw 50 may induce further convergence of the legs 22, 26.

Further, the location of the spreader jaw 50 within the clamping channel 20 is at least partially determined by design considerations and intended operating parameters, and thus the spreader jaw,can be located at a junction of one of the legs 22, 26 and the closed end 24. It is also contemplated the clamping channel 20 can include a plurality of spreader jaws 50 such as having a spreader jaw disposed at each junction of a leg and the closed end. Alternatively, a single spreader jaw 50 can be located at an offset or asymmetric location in the clamping channel 20. That is, the spreader jaw 50 can be located intermediate a junction of one leg and the closed end 24 and the centerline of the clamping channel 20.

The spreader jaw 50 can be formed without specific characteristics for enhancing light emission. However, it is understood the spreader jaw 50 can be formed with reflective surfaces, such as a lining or coating to enhance light emission. For example, the spreader jaw 50 can be coated with or formed of a light reflective material.

As seen in FIGS. 3-6, 9 and 10, in one configuration, the clamping channel 20 can be formed without structural metal. That is, at least the clamping channel 20 does not require a metal carrier or metal reinforcement for providing sufficient rigidity to perform the required functions. However, it is understood the clamping strip 10 can include metal in the form of a filler, trace amounts or colorants, and particularly those amounts that do not inhibit subsequent recycling of the polymer material. Such metal is in contrast to the structural metal sufficient to reinforce the clamping channel 20.

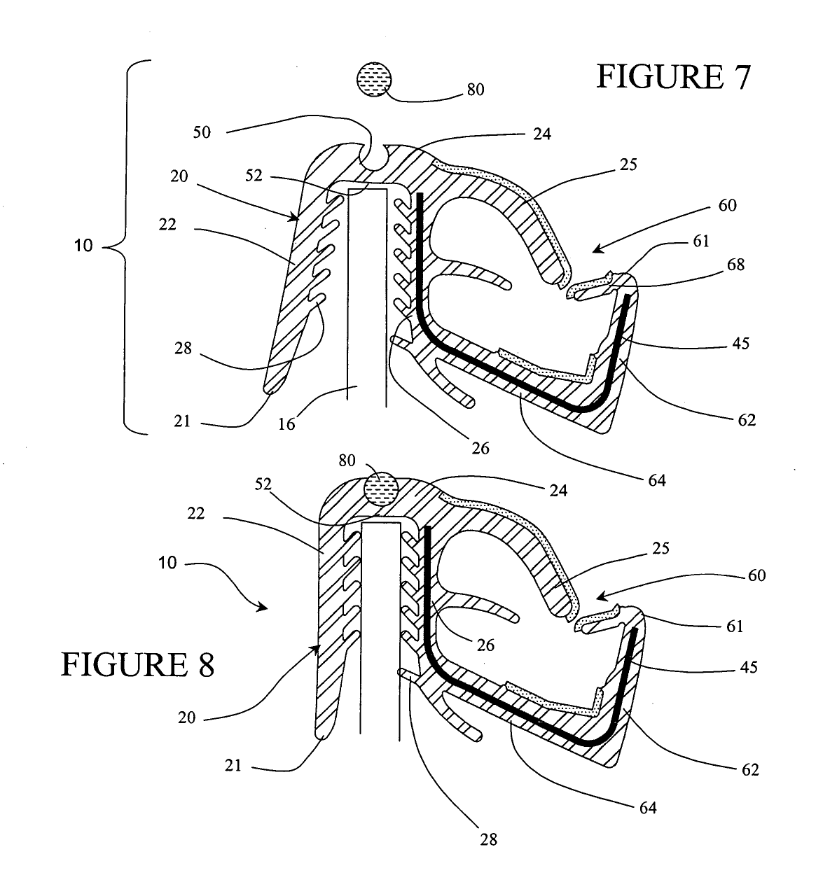

Referring to FIGS. 7 and 8, the clamping channel 20 can include an optional reinforcing member 45 such as a ribbon, thread, cord, cable, stamped metal, wire carrier or foil, which enhances rigidity or stability in at least a single dimension. The reinforcing member 45 can be a substantially inextendable cord that can provide stability along a longitudinal dimension of the clamping strip 10, while allowing the material of the clamping strip to define the rigidity in the transverse dimensions. The reinforcing member 45 is shown as a generally flat ribbon or tape which resists elongation along the longitudinal axis of the clamping channel 20 as well as resisting bending in a single transverse direction. Such reinforcing member 45 can be located in both legs 22 and 26, both the legs and the closed end 24 of the clamping channel 20 or in a single leg. Alternatively, the reinforcing member 45 can be in the configuration of a carrier and located within both the clamping channel 20 and a window receiving channel. The reinforcing member 45 can be any of a variety of materials, including but not limited to plastics, polymers, metals or fiberglass. The reinforcing member 45 can thereby reduce elongation along a longitudinal dimension, without increasing stability, or rigidity of the weatherseal 10 in one or two transverse dimensions.

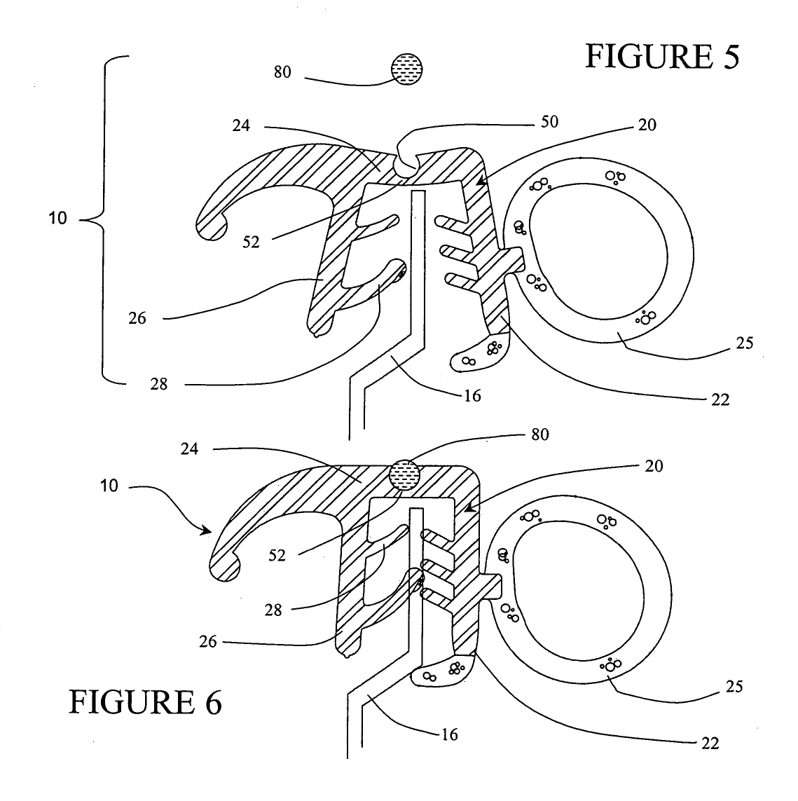

Optionally, as seen in FIGS. 5-10, a panel contacting member 25 can be connected to the clamping channel 20, such as by an integral connection. The panel contacting member 25 can be a sealing member or a trim member. That is, the panel contacting member 25 can form a sealed interface with the panel 14 or “trim out” a portion of vehicle to provide a finished exposed surface, which does not form a sealed interface. Typically, the panel contacting member 25 is a sealing member such as a bulb or a window receiving channel, and is transversely spaced from the clamping channel 20 along a length of the clamping strip 20. It is understood the panel contacting member 25 can be a static seal or a dynamic seal. One, two or more panel contacting members 25 can be incorporated with a clamping channel 20. Thus, each leg of the clamping channel 20 can include at least one panel contacting member 25, wherein the panel contacting members are sealing members, trim members or a combination thereof.

Referring to FIGS. 7 and 8, a glass run configuration of the clamping strip 10 is shown, such as extending along an A-pillar of the vehicle 12. In this configuration, the clamping strip 10 includes the clamping channel 20, the optical locking cord 80 and the panel contacting member 25, wherein the panel contacting member is an inverted window receiving channel 60 (often referred to as a glass run channel). The overall cross-sectional profile of the clamping strip 10 is thus a generally curvilinear or segmented S.

In the configuration of the panel contacting member 25 being a window receiving channel 60, as seen in FIGS. 7 and 8, the panel engaging member has a cross section defined by the second leg 26, a window channel closed end 64 and an exterior leg 62 projecting from the window channel closed end. The window channel closed end 64 provides a connection of the second leg 26 to the exterior leg 62. Depending upon the length of the second leg 26, the second leg can form a common leg of the clamping channel 20 and the window receiving channel 60 or can define a separate channel forming length corresponding to the respective first leg 22 or exterior leg 62. Thus, the second leg 26 can define a transition from the clamping channel 20 to the window receiving channel 60. The first leg 22 includes a free end 21, and the exterior leg 62 includes a free end 61.

In the glass run configuration, the exterior leg 62 of the panel contacting member 25, can include a sealing lip or fin 68 that projects into the window receiving channel 60 to contact the panel 14 as the panel is located within the window receiving channel.

The optical locking cord 80 is sized to be operably received within the spreader jaw 50 to dispose the spreader jaw into the clamping configuration. The optical locking cord 80 can be a substantially bulbous member sized to impart the motion to the spreader jaw 50.

Referring to FIGS. 5 and 6, in an alternative configuration, the panel contacting member 25 is a sealing member, such as a sealing bulb. In this configuration, the panel contacting member 25, is integrally connected to an outer surface of one of the legs of the clamping channel 20. The sealing member is formed to be resiliently deformable for repeatedly and releasably engaging a relatively moveable panel in a compression or sliding motion. The sealing member can be formed of a sponge or cellular structure, having open or closed cells.

The optical locking cord 80 is moveable relative to the spreader jaw 50 (and hence the clamping channel 20) between an open, uninstalled position and a locked (installed) position. Thus, the clamping strip 10 is moveable between an open, uninstalled position and an installed (flange engaging) position.

The spreader jaw 50 and the optical locking cord 80 are sized to move the legs 22 and 26 from a spread (splayed) position (FIGS. 3, 5, 7 and 9) to a locking (clamping) position (FIGS. 4, 6, 8 and 10) upon engagement of the optical locking cord with the spreader jaw. The amount of displacement between the open position and the closed position of the legs 22 and 26 can be controlled by the sizing of the spreader jaw 50 and optical locking cord 80. The configuration of the gripping fins 28 can also be controlled to assist in accommodating various flange thicknesses.

The optical locking cord 80 can be retained within the spreader jaw 50 by a variety of mechanisms including adhesives, bonding or mechanical retention. Depending upon the hardness or resiliency of the clamping channel 20 in which the spreader jaw 50 is formed, the optical locking cord 80 can be retained by friction or a snap fit.

Although the optical locking cord 80 is shown as having a generally circular cross-sectional profile, it is understood the light line can have a multi-facet, curvilinear, oval, obround, triangular, square, rectangular or other such cross-section. Typically, the optical locking cord 80 has a cross section complimentary to the spreader jaw 50. Further, the relative cross-sectional area of the optical locking cord 80 relative to the clamping channel 20 is dependent upon a number of parameters including the desired illumination, the construction of the optical locking cord as well as construction of the channel 20.

The optical locking cord 80 has sufficient rigidity or hardness to urge the clamping channel 20 to the closed position, and maintain a clamping bias by the clamping strip 10. Thus, as subsequently discussed, the optical locking cord 80 can include an embedded reinforcing polymer to provide the necessary rigidity or hardness. It is also contemplated the optical locking cord 80 can include a reinforcing member such as an inextensible elongate member including, but not limited to a cable, cord, fiber or wire.

In one construction, the optical locking cord 80 extends along substantially the entire length of the clamping strip 10. While the optical locking cord 80 can extend the length of the clamping strip 10, the entire length or intermittent portions of the strip can be optical.

The optical locking cord 80 is a separate component from the clamping channel 20 and subsequently engaged with the clamping channel. That is, the optical locking cord 80 is separately manufactured from the clamping channel 20 and subsequently engaged with the clamping channel at installation. However, even the separately constructed optical locking cord 80 can be partially engaged with the clamping channel 20, such as via the spreader jaw 50, while the clamping channel remains in the unloaded (splayed) configuration. Thus, the optical locking cord 80 can be separately constructed then sufficiently engaged with the spreader jaw 50 to allow handling and simultaneous locating of the splayed clamping channel 20 and the optical locking cord relative to the flange 14, wherein the optical locking cord is then fully engaged with the spreader jaw to dispose the clamping channel to the clamped (installed) configuration. It is also understood that further configurations of the clamping strip 10 can include the optical locking cord 80 tethered to the clamping channel 20 in the uninstalled (splayed) position, wherein the optical locking cord is movable to the clamped position while remaining tethered to the clamping channel, thereby disposing the clamping channel in the clamped position.

Generally, the optical locking cord 80 can be active such as self-illuminating, passive, such as merely transmitting and emitting light or reflective to a degree greater than diffuse reflection. That is, the optical locking cord 80 is one of light emitting, light generating or specular reflective, or at least diffractive. It is also contemplated, the optical locking cord 80 can include reflective surfaces to control direction of emitted light. Therefore, depending upon the amount of lighting required, a variety of constructions can be used as the optical locking cord 80.

In the active or passive configuration of the optical locking cord 80, the optical locking cord emits light along a path that defines a non-zero angle with a longitudinal dimension or axis of the cord or the clamping strip 10. The optical path of the emitted light will intersect the longitudinal axis. Therefore, the optical locking cord 80 emits light along paths that are non parallel to the longitudinal dimension. The light passes from the optical locking cord 80 along the length of the optical locking cord. That is, light passes from the optical locking cord 80 intermediate the ends of the optical locking cord. The areas or sections of light emission can be determined in response to the intended operating characteristics of the clamping strip 10. The self-illuminating (active) configuration of the optical locking cord 80 can include light ropes, LEDs and LED strings. The transmitting/emitting (passive) optical locking cord 80 can include fiber optics and side emitting fiber optics, such as glass plastic or composites. An example of the optical locking cord 80 includes the Bridgestone Luxaura™ light guide, which generally includes an LED illuminator optically coupled to an elongate acrylic body, wherein cladding is employed to render the light guide side emitting.

It is understood the optical locking cord 80 can include intermittent or discrete light sources or emitters extending along the longitudinal dimension of the optical locking cord. The optical locking cord 80 can thereby provide a plurality of points of light along the longitudinal dimension. Thus, the optical locking cord 80 can be selected to provide substantially continuous light emission along the longitudinal dimension, intermittent light or an intermediate light dispersion along the longitudinal dimension.

The optical locking cord 80 can include sheathing or cladding to assist in providing a bond between a glass fiber optic and an encapsulating polymer. The encapsulating polymer can be selected to provide a desired degree of hardness or rigidity to the optical locking cord. The embedding polymer can be translucent or transparent, and thermoset, thermoplastic or a thermoplastic elastomer. A representative material is polyethylene or acrylic.

Alternatively, the spreader jaw 50 can be formed of, or coated with, light absorbing material to reduce light transmission. Similarly, the cross sectional profile of the spreader jaw 50 can be structured to enhance or inhibit light transmission as dictated by the intended operating environment and the structure of the particular optical locking cord 80.

The transmitting/emitting optical locking cord 80 cooperates with a light source. The light source can be dedicated to the optical locking cord 80. Alternatively, the light source can be employed for additional uses such as courtesy lights, warning lights or dome lights. The light source can be any of a variety of types such as incandescent, fluorescent, light emitting diode (LED) or lasing.

The emission of light from the optical locking cord 80 can be controlled by a variety of mechanisms, wherein the mechanism actuates the light source or the optical interconnection of the optical locking cord to the light source. Capacitive, pressure or contact switches can be employed with the clamping channel 20 to selectively provide illumination wherein the switch can be integral with or external to the clamping channel. In addition, optical locking cord 80 can be controlled to provide any of a variety of light characteristics such as dimming, pulsing, chasing, blinking or constant.

For example, the optical locking cord 80 can be illuminated in response to an opening or closing of a door. Alternatively, the optical locking cord 80 can be illuminated for a timed interval in response to a predetermined condition or event.

A switch mechanism for controlling the emission of light from the optical locking cord 80 can be incorporated into the clamping strip 10. The switch mechanism can include a pressure or deflection type switch, a touch sensitive switch, a capacitive switch or a combination of pressure and touch sensitive switches. In one construction, the switch is integral with the clamping channel 20. It is contemplated the switch can extend along the length of the channel 20, or along selected portions. Thus, the clamping strip 10 can be activated through a switch integrated with the strip. The switch can be activated by a flexing of the strip, or location of a dielectric material adjacent the clamping strip 10.

For the reflective configuration, the optical locking cord 80 exhibits at least diffractive and, in certain configurations, specular reflection. That is, in contrast to a diffuse reflector, such as existing locking cords (in which the surface merely scatters radiation incident on the surface, thus producing diffuse reflection), the present reflective surface of the optical locking cord 80 is specular as the light is reflected, as by a mirror or speculum.

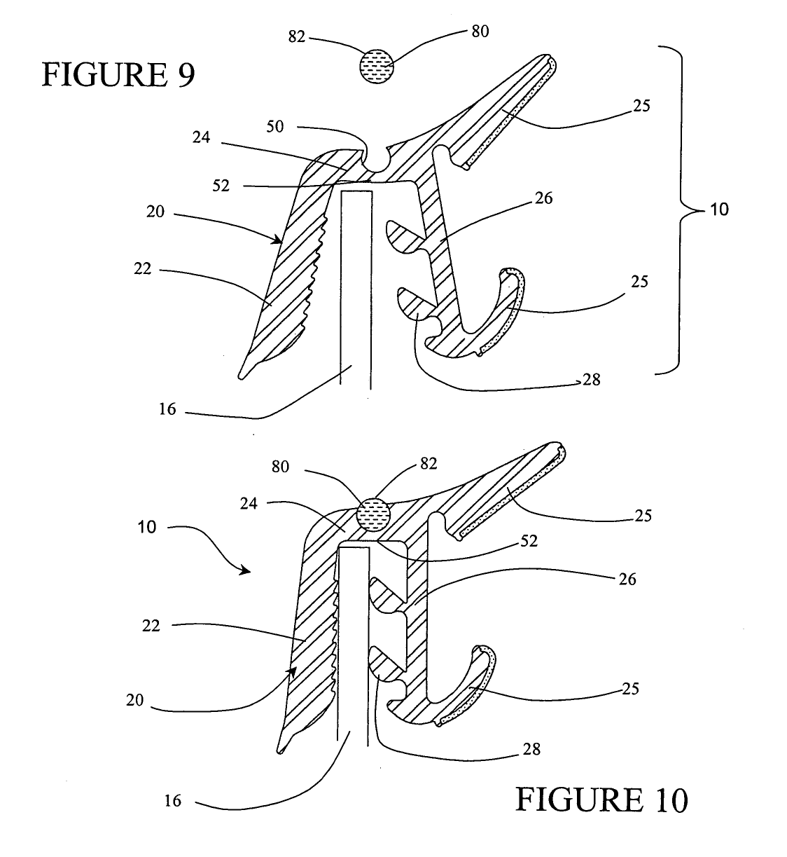

As seen in FIGS. 9 and 10, the reflective optical locking cord 80 can have a reflective surface 82 formed in a variety of configurations. Generally, the reflective surface 82 is formed as a film, layer, flock, textile, cord or laminate, by any of a variety of processes, including but not limited to an extrusion, spray, sputter, molding or colliquefaction.

The reflective surface 82 can be an extrudate, a reflective cloth extruded, or coextruded, with the corresponding portion of the optical locking cord 80, or a preformed strip applied by extrusion. Textile includes, but is not limited, to woven, pile or cut fibers. Alternatively, the reflective surface 82 can be formed from a colliquefaction. Further, the reflective surface 82 can be the exposed surface of the optical locking cord 80. That is, the entire optical locking cord 80 can be formed of a reflective material. The reflective surface 82 thus forms the exposed surface of the portion of the optical locking cord 80.

The reflective extrudate forming the reflective surface 82 can include reflective particles within a non-reflective matrix. The reflective particles can include glass or plastic microspheres, particles, crushed particles, fractured particles or beads, which are reflective, refractive, reflex reflective, retroreflective, prismatic, externally coated, internally coated, fluorescent or photoluminescent. It is contemplated the reflective particles can be disposed within a non-reflective matrix, as well as on the surface of a non-reflective matrix. Alternatively, the entire extrudate can be formed of a generally reflective material. For example, a reflective thermoplastic, thermoplastic elastomer or thermoset can be extruded, without requiring the addition of the reflective particles.

The reflective configuration can also be formed by a colliquefaction. In the colliquefaction configuration, which can include a contiguous colliquefaction, the reflective surface 82 is a film formed from a powder coating applied to the locking cord 80 and subsequently melted to form a reflective surface and preferably continuous surface layer. Thus, the reflective surface 82 is a colliquefied powder coating forming a contiguous layer. The reflective surface 82 is preferably bonded to the clamping channel 20 to preclude non-destructive separation. In an alternative configuration, the colliquefied powder coating can form discrete reflective locations on the optical locking cord 80.

In certain constructions, the reflective surface 82 is a film having a thickness which is sufficiently small to provide flexibility in the film. The flexibility of the film forming the reflective surface 82 does not detrimentally reduce the flexibility of the optical locking cord 80. Thus, the film can conform with the clamping strip 10 during flexures.

The film can be formed of a powder coating. It is also contemplated the powder coating can be used to coat the spreader jaw 50 with an optically desirable surface. Powder coatings are finely ground plastic particles including resin, a crosslinker in thermoset powders, pigments, extenders, and various flow additives and fillers to achieve specific properties. Powder coatings are applied as a dry material and when the powder coating is heated, the particles colliquefy (melt) to form a contiguous film, which is typically very durable and chemical resistant. Powder coating materials can be thermoplastic or thermoset. The thermoplastic powders do not chemically react in a cure phase during colliquefaction.

Thermoset powder coatings are applied and then cured, typically in an oven at a certain temperature for a certain time. The cure process will cause a chemical crosslinking to take place, changing the powder into a contiguous film that will not remelt.

The powder coating can be formulated to create the film which is the reflective surface 82. That is, the reflective surface 82 can be formed from a powder coating so that incident light reflects from the reflective surface. That is, the film resulting from the powder coating can be reflective. The powder coatings can include glass or plastic microspheres, particles, crushed particles, fractured particles or beads, which are reflective, refractive, reflex reflective, retroreflective, prismatic, externally coated, internally coated, fluorescent or photoluminescent in combination with the film forming powder coating. It is contemplated the reflective particles can be disposed within a non-reflective powder coating.

A thermoset powder coating for the reflective surface 82 can include a resin particle containing a thermosetting resin, and a particle containing a curing agent.

A thermosetting resin used in the powder coating can include epoxy resins, acrylic resins, phenol resins and polyester resins. These thermosetting resins can be used alone, or combined together with two or more kinds. In particular, a thermosetting resin having an epoxy group (that is, glycidyl group), such as epoxy resins, acrylic resins are available. These thermosetting resins have excellent reactivity to a curing agent comprising the curing particles, even at relatively low temperatures, for example, 120° C. or less.

A latent curing agent such as dicyandiamide, imidazolines, hydrazines, acid anhydrides, blocked isocyanates, and dibasic acids can be added to the resin particles as a curing promoter. The latent curing agent is typically stable at room temperature, and crosslinks with a thermosetting resin in a range of 140° C. to 260° C. It is understood any of a variety of cross-linking agents can be employed.

The use of a colliquefied powder coating to form the reflective surface film 82 allows the processing parameters to be maximized for the given component. That is, the processing (temperatures and pressures) of the clamping channel 20 do not need to accommodate the processing parameters of the powder coating to be liquefied.

Suitable powder coatings, as sold by Morton Powder Coating of Warsaw, Ind., include DG-5001 CORVELL® BLUE (ethylene/Acrylic), DG-7001 CORVEL® BLACK 20 (Ethylene/Acrylic), 78-7001 CORVEL® BLACK (Nylon) and 70-2006 CORVEL® YELLOW (Nylon), wherein the reflective particles are incorporated into the powder coating.

Alternatively, the powder coating can be a material that becomes or acquires reflectivity upon colliquefaction. That is, the material becomes reflective as a result of the heating and colliquefaction.

The clamping channel 20 is formed of a polymeric material, and preferably a polymeric material having sufficient rigidity to perform the intended functions. A material that has been found suitable is a structural grade polypropylene. It is understood that comparably rigid thermoset materials can be employed. However, use of thermoset materials requires additional processing steps for recycling of the thermoset materials. In contrast, thermoplastic materials can be readily remelted and reconfigured into subsequent products.

The clamping channel 20 can be formed from a number of different plastic materials, for example, thermoplastics and thermoplastic elastomers (TPEs). Depending on the hardness, TPEs are sometimes categorized as thermoplastics and sometimes as elastomers. For purposes of this invention, no such distinction will be made, and hard and soft grades of plastic will all be referred to as TPEs.

TPEs are commercially available in several different brands and types. Each type can be obtained in different grades having different properties such as hardness, tensile strength, compression, elongation, thermal stability and colorability. Selection of the appropriate TPE for a particular application depends on a suitable combination for such properties. Types of TPEs that are particularly useful are styrenic block co-polymers, rubber polyolefin blends, elastomeric alloys, thermoplastic alloys, thermoplastic elastomeric alloys, thermoplastic isomers, thermoplastic polyurethanes, polyvinyl chlorides and blends thereof.

Polyvinyl chloride (PVC) based TPEs are also suitable for window seals and are available in different grades and blends with other TPEs and rubbers. P-Valloy is one such material available from GBIE (Gerry Bareich Import Export Inc.) of Canada.

Formation of the clamping strip 10 can be by extrusion or molding as well known in the industry and for the present materials. Specifically, the formation of the clamping channel 20 and any associated panel contacting member 25 and gripping fins 28 can be provided by an extrusion die or dies, as well as various mold configurations.

In installation of the clamping strip 10, the optical locking cord 80 is initially in the open, uninstalled position, such that the first leg 22 and the second leg 26 are slightly splayed and the spreader jaw 50 is unloaded. The splayed clamping channel 20 is disposed over the flange 16 of the vehicle 12. The optical locking cord 80 is moved to the installed position so as to be disposed in the spreader jaw 50. As the optical locking cord 80 is disposed into the spreader jaw 50, the first leg 22 is urged towards the second leg 26 and the gripping fins 28 in the clamping channel 20 compress on the flange 16. A varying thickness of the flange 16 is at least partially accommodated by the sizing of the gripping fins 28.

While the invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A vehicular clamping strip, comprising:
(a) a clamping channel having a closed end and a pair of projecting legs, an outer surface of the clamping channel including a spreader jaw; and
(b) an optical locking cord sized to cooperatively engage the spreader jaw to urge the clamping channel to a clamping configuration, the optical locking cord being at least one of light emitting, light generating and specularly reflective.

2. The vehicular clamping strip of claim 1, wherein the optical locking cord is light emitting.

3. The vehicular clamping strip of claim 1, wherein the optical locking cord is light generating.

4. The vehicular clamping strip of claim 1, wherein the optical locking cord is specularly reflective.

5. The vehicular clamping strip of claim 1, further comprising a reflective surface on the optical locking cord, the reflective surface being specularly reflective.

6. The vehicular clamping strip of claim 1, wherein the spreader jaw is in the closed end.

7. The vehicular clamping strip of claim 1, further comprising a panel contacting member connected to the clamping channel.

8. The vehicular clamping strip of claim 7, wherein the panel contacting member is a sealing member.

9. The vehicular clamping strip of claim 8, wherein the panel contacting member is a sealing bulb.

10. The vehicular clamping strip of claim 7, wherein the panel contacting member includes a glass receiving channel having a second closed end extending from one of the projecting legs and a second leg projecting from the second closed end.

11. The vehicular clamping strip of claim 1, further comprising a reinforcing member in one of the projecting legs.

12. The vehicular clamping strip of claim 1, further comprising a static seal panel contacting member.

13. The vehicular weatherseal of claim 1, further comprising a dynamic seal panel contacting member.

14. The vehicular weatherseal of claim 1, further comprising a gripping fin extending from one of the projecting legs.

15. The vehicular weatherseal of claim 1, further comprising a reinforcing member within the optical locking cord.

16. The vehicular clamping strip of claim 1, wherein the optical locking cord is tethered to the clamping channel.

17. The vehicular clamping strip of claim 1, wherein the optical locking cord is partially engaged with the spreader jaw in an uninstalled state of the clamping channel.

18. A method of forming a vehicular weatherseal, comprising:
(a) forming a clamping channel having a closed end and a pair of projecting legs, an outer surface of the clamping channel including a spreader jaw; and
(b) cooperatively engaging an optical locking cord with the spreader jaw to urge the clamping channel to a clamping configuration, the optical locking cord being at least one of light emitting, light generating and specularly reflective.

19. The method of claim 18, further comprising connecting a trim piece to the clamping channel.

20. The method of claim 18, further comprising connecting a sealing member to the clamping channel.

21. The method of claim 18, further comprising forming a glass receiving channel adjacent the clamping channel.

22. The method of claim 21, further comprising forming a panel contacting surface within the glass receiving channel.

23. The method of claim 20, further comprising forming the sealing member as a bulb.

24. The method of claim 20, further comprising forming the sealing member to include a cellular structure.

25. The method of claim 18, further comprising disposing a reinforcing member in the clamping channel.

26. The method of claim 20, further comprising forming the sealing member as a static seal.

27. The method of claim 20, further comprising forming the sealing member as a dynamic seal.

28. The method of claim 18, further comprising forming a gripping fin extending from one of the projecting legs for contacting the flange.

29. The method of claim 18, further comprising forming the clamping channel of recyclable material.

30. The method of claim 18, wherein forming the clamping channel includes extruding the clamping channel.

31. The method of claim 18, wherein forming the clamping channel includes molding at least a portion of the clamping channel.

32. The method of claim 18, further comprising tethering the optical locking cord to the clamping channel prior to cooperatively engaging the optical locking cord with the spreader jaw.

33. The method of claim 18, further comprising locating a reinforcing member within the optical locking cord.

34. The method of claim 18, further comprising extruding the optical locking cord.

35. The method of claim 18, further comprising molding at least a portion of the optical locking cord.
